(19) United States
(12) Patent Application Publication
(10) Pub. No.: US 2011/0027892 A1
(43) Pub. Date: Feb. 3, 2011

(54) METHODS AND SYSTEMS FOR IDENTIFICATION, EXTRACTION, AND TRANSFER OF ANALYTICAL DATA FOR PROCESS CONTROL

(75) Inventors: Marcel J. Meacham, Mendon, MA (US); George E. Barringer, JR., West Groton, MA (US); Vipin Saini, Lowell, MA (US); John H. Mentzer, Leominster, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Groton Biosystems, LLC, Boxborough, MA (US)

(21) Appl. No.: 12/826,048

(22) Filed: Jun. 29, 2010

Related U.S. Application Data
(60) Provisional application No. 61/222,014, filed on Jun. 30, 2009.

(51) Int. Cl. G01N 35/00

(52) U.S. Cl. 436/43; 422/62

(57) ABSTRACT

Disclosed are methods, apparatuses, and systems, for (1) providing reliable identification of analytes from an HPLC or other analytical instrument, (2) ensuring data integrity during transfer of analytical data from the instrument to, for example, a control application or other destination, and (3) near-immediate transfer of the data after analysis. Embodiments include methods, apparatuses, and systems that automatically identify a subset of analytes from a plurality of analytes able to be analyzed by a liquid chromatograph (or similar instrument) and that automatically extract a subset of result data from the instrument, where the result data relates to a liquid mixture sample from a reactor (or other source) and where the subset of data corresponds to the subset of analytes. The subset of data may then be used to control a reactor process, or other process, by, for example, transferring the subset of data to a control application.

### RELATED APPLICATION

This application claims the benefit of U.S. Provisional Application No. 61/222,014, filed on Jun. 30, 2009. The entire teachings of the above application are incorporated herein by reference.

### BACKGROUND OF THE INVENTION

In a bioreactor process, collecting analytical data to study and maintain the process is key. Whenever the collection is performed manually, the data faces the risk of being lost or incorrectly transcribed into a data repository. Typical bioprocesses involve manual sampling where a sample from the reactor is analyzed at an instrument station, analytical data is written on paper, and the written data is later entered into a database. A High-Performance Liquid Chromatography (HPLC) system is one kind of system that is used to analyze reactor samples. The term “analyte” is used to refer to a substance or chemical constituent (e.g., glucose) that is examined during an analytical procedure, such as HPLC.

The concentration of an analyte in the media sample from a reactor is used to determine the state of the culture. Sample analysis instruments, such as a Liquid Chromatograph (LC), have some means of detecting the presence of analytes. Analytes enter a detector of the instrument, and the instrument generates an electronic signal called a response. Some analysis instruments can translate this response into a concentration value of the analyte in the sample. Information about an analyte's concentration value can be used to determine how to feed and maintain the culture in the reactor.

### SUMMARY OF THE INVENTION

Currently, High-Performance Liquid Chromatography (HPLC) systems do not lend themselves to automatically sending specific identified analytes and analyte concentration values to historian databases or applications (such as reactor control systems that feed and care for reactor processes). Instead the user of the HPLC system must wait or come back for the HPLC report that is generated with a chromatogram resulting from the analysis of the sample. The user must then search through a table, for example, containing rows of analyte entries with columns of analytical results looking for specific analytes and data point values of interest to the user. The user then manually records the analyte's name, concentration value, and any other result value from the data analysis table, and may need to re-enter the recorded data multiple times into various databases or applications.

This manual process is susceptible to human error in various ways: (1) error during identification of the analytes of interest, (2) error during copying of the data from the analytical instrument's output to a clipboard, for example, and (3) error during entering of the data into a database or control application. In addition, this manual process delays the results of the HPLC analysis from being sent to applications (such as a reactor's control system for corrective action to be taken to optimize the operation and feeding of the reactor). What is needed is a method, and associated apparatuses or systems, for (1) providing reliable identification of the analytes from the HPLC instrument, (2) ensuring data integrity during transfer of the analytical data from the instrument to other applications, and (3) immediate transfer of the data after analysis.

One example method for controlling a process includes automatically identifying a subset of analytes from a plurality of analytes able to be analyzed by a liquid chromatograph, and automatically extracting a subset of data from the liquid chromatograph, where the data relates to a liquid mixture sample from a reactor and where the subset of data corresponds to the subset of analytes. The subset of data is then transferred to an application associated with the reactor and the reactor is controlled in response to the subset of data.

In some embodiments, automatically identifying the subset of analytes may include examining groups of data output from the liquid chromatograph (e.g., a row of result values in a table of results) where each group of data corresponds to a respective analyte detected by the liquid chromatograph. In such embodiments, examining the groups of data may include determining whether the liquid chromatograph has been calibrated for the analyte corresponding to the group of data by determining if the group of data includes a name for the given analyte. If the liquid chromatograph has been calibrated for the given analyte, then that given analyte is identified. Embodiments may also identify analytes based on whether a group of data corresponding to an analyte includes a retention time that falls within a specified range.

Embodiments may extract data from the liquid chromatograph by obtaining the data from a report output by the liquid chromatograph or from internal registers of the liquid chromatograph, and in some embodiments, automatically extracting a subset of data may include extracting groups of data that correspond to the subset of analytes, where certain values from each group of data are extracted. Examples of the certain values may include, but are not limited to, analyte name, analyte type, retention time, peak width, peak area, peak area percent, and concentration. It should be noted that fewer values may be extracted from each group than are present in the group. During extraction, analyte concentration values may be extracted. For a given analyte, if the concentration value is not explicitly present in the corresponding group of data, the concentration value may be calculated based on a peak area value of the analyte, as included in the corresponding group of data, and a specified response factor for the analyte. The extracted subset of data may be formatted into an Object Linking and Embedding for Process Control (OPC) compliant format for use by a reactor controller or other application.

An example apparatus for controlling a process is device that includes (1) an identification module that is configured to automatically identify a subset of analytes from a plurality of analytes able to be analyzed by an analytical instrument, (2) an extraction module that is configured to automatically extract a subset of data from the analytical instrument, where the data relates to a liquid mixture sample from a reactor and where the subset of data corresponds to the subset of analytes, and (3) an interface configured to transfer the subset of data to an application associated with the reactor to control the reactor in response to the subset of data.

In some embodiments, the given analytical instrument is a liquid chromatograph, and the device for controlling the process is an automated reactor sampling device, a liquid chromatograph, or other device in communication with an automated reactor sampling device and the given analytical instrument.

Another example method for controlling a process includes automatically identifying a subset of analytes from a plurality of analytes able to be analyzed by a given analytical instrument, and automatically extracting a subset of data from the given analytical instrument relating to the process, where the subset of data corresponds to the subset of analytes. The process is then controlled in response to the subset of data.

The example embodiments disclosed herein reduce the risk of analyte misidentification and mistranslation during the transfer of analytical data from an HPLC instrument to other applications. The time of the data transfer is also minimized.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating a system for performing High-Performance Liquid Chromatography (HPLC) of a liquid sample from a reactor using an Automated Reactor Sampling (ARS) system.

FIG. 2 is a block diagram illustrating an example embodiment for controlling a reactor process based on results from a High-Performance Liquid Chromatography (HPLC) analysis of a sample from the reactor.

FIG. 3 is a flow diagram illustrating an embodiment for automatically controlling a reactor process based on results from a High-Performance Liquid Chromatography (HPLC) analysis of a sample from the reactor.

FIG. 4A is a detailed flow diagram illustrating identifying a subset of analytes in an example method for process control.

FIG. 4B is a schematic diagram illustrating the contents of an example report file output by a High-Performance Liquid Chromatography (HPLC) system.

FIG. 5 is a detailed flow diagram illustrating extracting a subset of data corresponding to a subset of analytes in an example method for process control.

FIG. 6 is a block diagram illustrating an example Automated Reactor Sampling (ARS) system configured to control a reactor process.

FIG. 7 is a block diagram illustrating an example High-Performance Liquid Chromatograph (HPLC) configured to control a reactor process.

FIG. 8 is a block diagram illustrating an example ARS and HPLC controller that is configured to control a reactor process.

FIG. 9 is a block diagram illustrating files accessed by ARS and HPLC controllers and used to pass information between the controllers.

FIG. 10 is a block diagram illustrating an example embodiment for generating analyte data files and associated Object Linking and Embedding for Process Control (OPC) tags.

FIG. 11 is a schematic diagram illustrating an example user interface to a system for controlling a reactor process.

### DETAILED DESCRIPTION OF THE INVENTION

A description of example embodiments of the invention follows.

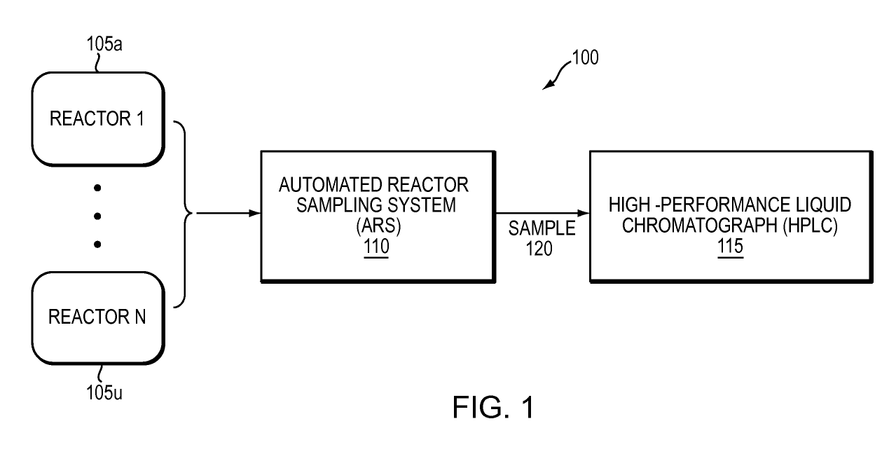

FIG. 1 is a block diagram illustrating a system 100 for performing High-Performance Liquid Chromatography of a liquid sample 120 from a reactor 105 using an Automated Reactor Sampling (ARS) system 110. The ARS 110 obtains a sample 120 from one of the reactors 105a-n and transfers the sample 120, in this embodiment, to a High-Performance Liquid Chromatograph (HPLC) 115. The system includes a pump that moves the sample through a column and a detector that determines retention times of various analytes in the sample as they move through the column. HPLC is a form of column chromatography used to separate, identify, and quantify compounds (analytes). An HPLC device uses a column that separates mixtures into a flow stream of separate analytes based on physicochemical parameters. Analytes' retention times vary depending on the interactions between the analytes in the sample and the materials in the column. To obtain an accurate reading, an HPLC is generally calibrated for given analytes using calibration curves for the analytes, as is generally known in the art.

HPLC instruments, for each run on a given sample, produce a chromatogram showing a set of analytes present in the sample, their retention times, and their peak values. The size of the peak is proportional to the concentration of the analyte. To calculate the concentration value of an analyte, the user may generate a calibration curve for the analyte using a number of known concentrations called standards, as known in the art. Calibration curves are generally constructed for each analyte of interest. The calibration curve is a graph where concentration is plotted along the x-axis and peak area is plotted along the y-axis. For each analyte with a defined calibration curve, the HPLC instrument may apply the analyte's peak area to the calibration curve to find the analyte's concentration value. Once obtained, the HPLC results may be used to adjust the conditions of the reactor 105 or may be recorded for future reference.

Most analytical instruments can detect only a finite number of analytes. HPLC instruments, on the other hand, can detect any of a large number of analytes. This is because many different columns may be made for use with an HPLC instrument, each column being used to detect a particular combination of analytes. There are currently 100's to 1000's of different columns from different manufacturers, and many 1000's of analytes. The resulting combination of columns and analytes is extremely large.

It would be beneficial to avoid the manual process of identifying and transcribing HPLC results for use with, for example, a reactor control system, but because of the near-infinite number of possible outputs from an HPLC system, results from HPLC analysis cannot simply be passed to and used by, for example, an application for reactor control. Result data from other instruments that detect only a small, consistent number of analytes is generally able to be passed to and used by other applications due to the consistent format of the results, i.e., information regarding the same set of analytes is always passed to the application. Thus, the application can feasibly be configured to meaningfully interpret the results. If the capability to detect an additional analyte is added to the instrument, the application receiving the results may be updated accordingly. It is not straight-forward, however, to configure a system to meaningfully interpret results from an HPLC instrument due to the near-infinite variations in result data. Each run of the HPLC instrument may result in different result data being provided, that is, for example, different combinations of analytes. A reactor control system, or other application, cannot meaningfully use such data that varies from run to run. Thus, it is not feasible to simply feed the HPLC results back into a control system or other application. This is one reason why the process is still carried out manually today.

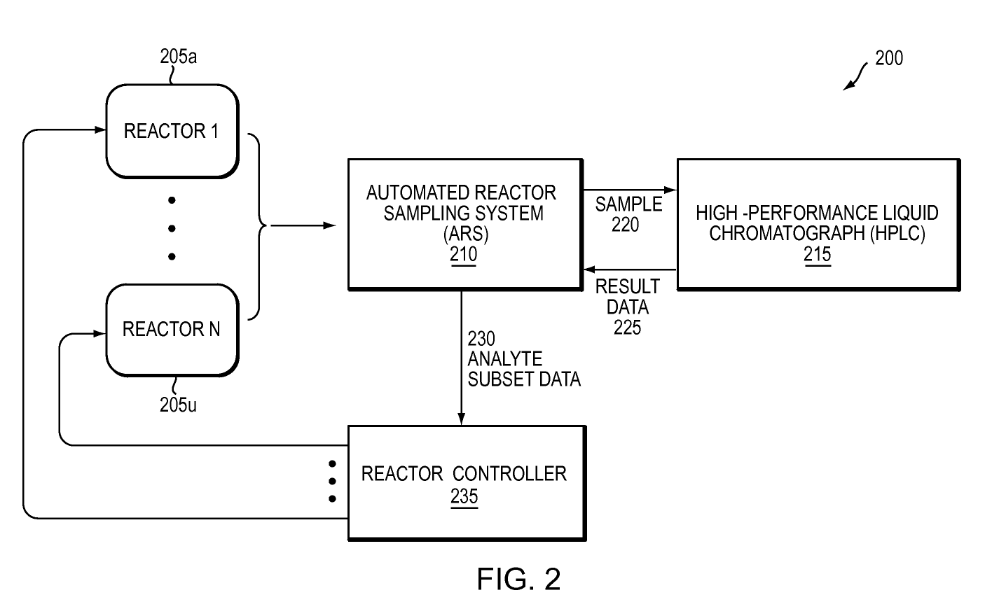

FIG. 2 is a block diagram illustrating an example system 200 for controlling a reactor's process based on results 225 from a High-Performance Liquid Chromatography (HPLC) analysis of a sample 220 from the reactor 205. According to the illustrated embodiment, the ARS 210 obtains result data 225 from the HPLC instrument 215 and passes a subset 230 of the data 225 to a reactor controller 235. Before providing the subset 230 to the controller 235, the ARS 210 automatically identifies a subset of analytes of interest from the many analytes that are able to be analyzed by the HPLC instrument 215. The ARS 210 then automatically extracts a subset 230 of the result data 225 that corresponds to the subset of analytes. After extraction, the ARS 210 transfers the subset of data 230 to an application associated with the reactor 205, such as the reactor controller 235, for controlling the reactor 205 in response to the subset of data 230.

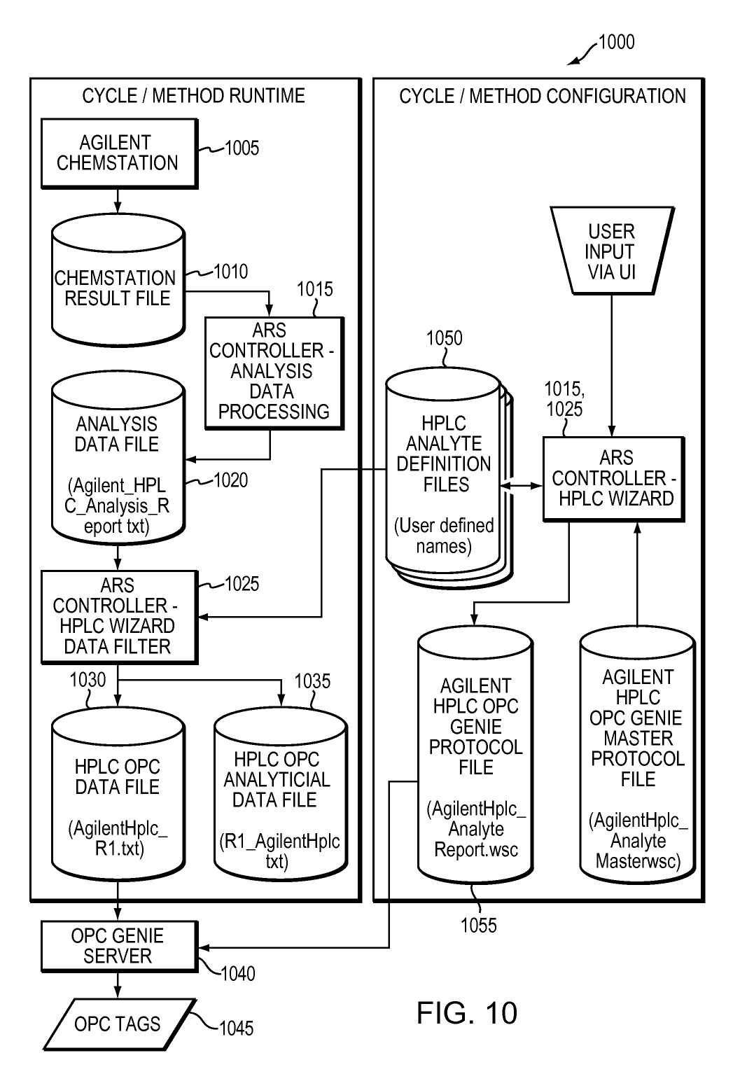

In some embodiments, automatically identifying the subset of analytes may include examining groups of data output from the HPLC (e.g., a row of result values in a table of results) where each group of data corresponds to a respective analyte detected by the HPLC instrument. In such embodiments, examining the groups of data may include determining whether the HPLC has been calibrated for the analyte corresponding to the group of data by determining if the group of data includes a name for the given analyte. If the HPLC has been calibrated for the given analyte, then that given analyte is identified. Alternatively, or in addition to identifying an analyte based on HPLC calibration, examining the groups of data may include determining whether a given group of data indicates, for its corresponding analyte, a retention time that falls within a range specified by a user, for example, using a wizard as described below in connection with FIG. 10. If the retention time is within the specified range, then the corresponding analyte is identified.

In some embodiments, automatically extracting a subset of data may include extracting groups of data that correspond to the subset of analytes, where certain values from each group of data are extracted. Examples of the certain values may include, but are not limited to, analyte name, analyte type, retention time, peak width, peak area, peak area percent, and concentration. It should be noted that fewer values may be extracted from each group than are present in the group. During extraction, analyte concentration values may be extracted. For a given analyte, if the concentration value is not explicitly present in the corresponding group of data, the concentration value may be calculated based on a peak area value of the analyte, as included in the corresponding group of data, and a specified response factor for the analyte. The extracted subset of data may be formatted into an Object Linking and Embedding for Process Control (OPC) compliant format for use by a reactor controller or other application.

The data may be stored in a database for future analysis on the sample, or it can be sent to an application (such as an reactor control system that feeds and maintains the reactor process).

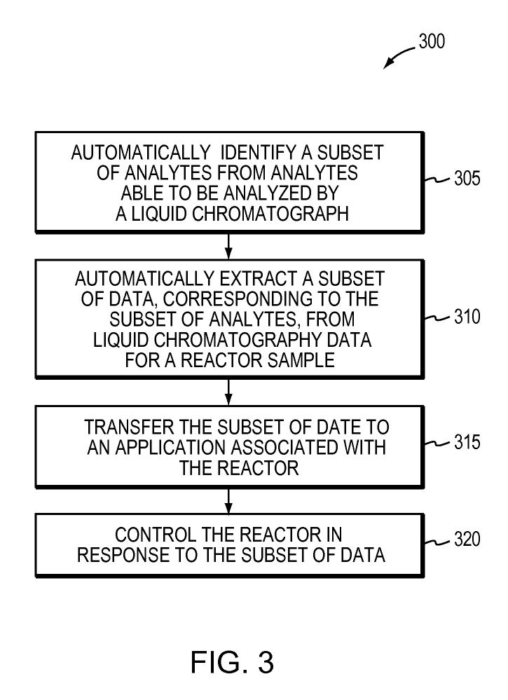

FIG. 3 is a flow diagram illustrating an example method 300 for automatically controlling a reactor process based on results from a High-Performance Liquid Chromatography (HPLC) analysis of a sample from the reactor. According to the illustrated method, a subset of analytes from a plurality of analytes able to be analyzed by the HPLC is automatically identified (305). For a liquid mixture sample from a reactor analyzed by the HPLC, a subset of data from the HPLC's resulting data is automatically extracted, where the subset of data corresponds to the identified subset of analytes (310). The subset of data is then transferred to an application associated with the reactor (315), and the reactor is controlled in response to the subset of data (320).

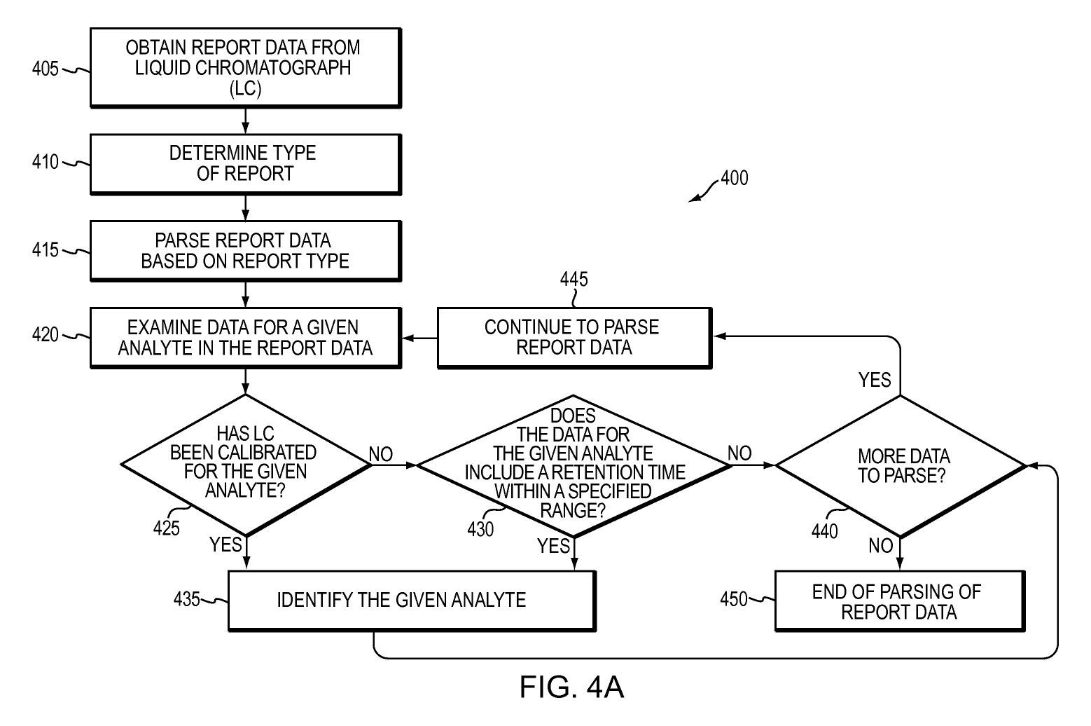

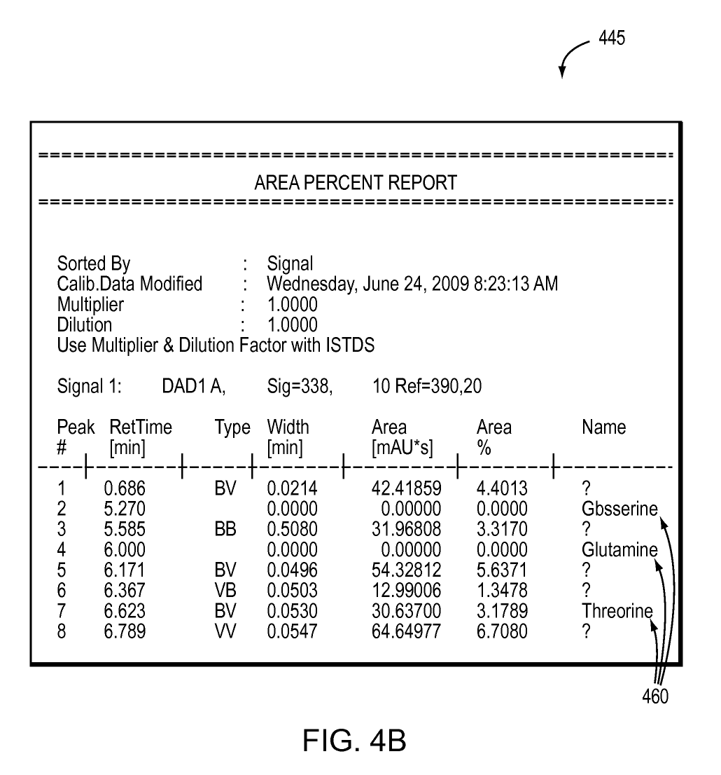

FIG. 4A is a detailed flow diagram illustrating an example method 400 of identifying a subset of analytes in an example method for process control. According to the method 400, report data is obtained from a liquid chromatograph (LC) instrument (405). The LC instrument may write the report data to a file, from which the data is then obtained, or the report data may be read directly from the instrument (e.g., from internal registers). Once the report data is obtained, the type or format of the report is determined (410). Some well-known report formats include Area Percent Report or External Standard Report. These two types of reports, for example, typically include result data in a tabular format where each row of the table includes data for a given analyte and each column includes a particular type of data (e.g., analyte name, analyte type, retention time, peak width, peak area, peak area percent, or concentration). The report data is then parsed based on the type of the report (415). While parsing the data, data for the analytes included in the report is analyzed (420). To identify the subset of analytes, the example embodiment determines whether the LC instrument has been calibrated for a given analyte (425). If so, the analyte is identified as an analyte of interest (435). If not, then the example embodiment determines whether the data for the analyte includes a retention time that falls within a specified range (e.g., range specified by a user) (430). If so, the analyte is identified as an analyte of interest (435). Once the data for the given analyte has been examined, the method determines if there is any more data to parse (440). If so, the method continues to parse the report data (445). If not, then the parsing of the report ends (450).

FIG. 4B is an example of a report 455 that may be generated by an HPLC system. The report 455 includes header information followed by a table of data regarding analytes found in the sample analyzed by the system. The format of the particular report 455 shown is an Area Percent Report format. For simplicity, the table is shown as including only eight analytes, but typical reports may include many more. Values for each analyte listed in the report are: analyte peak number, retention time, analyte type, peak width, peak area, peak area percent, and analyte name. Each line of data for an analyte may be referred to herein as a group of data. As shown, not every analyte listed in the report includes a name, and only three analytes 460 have names in the report 455. This means that the HPLC system has likely only been calibrated for those three analytes 460. The embodiments described herein may use the presence of these names to identify the three analytes 460 as being the analytes of interest. Upon extraction of the data from the report 455, only data for the three analytes 460 is extracted.

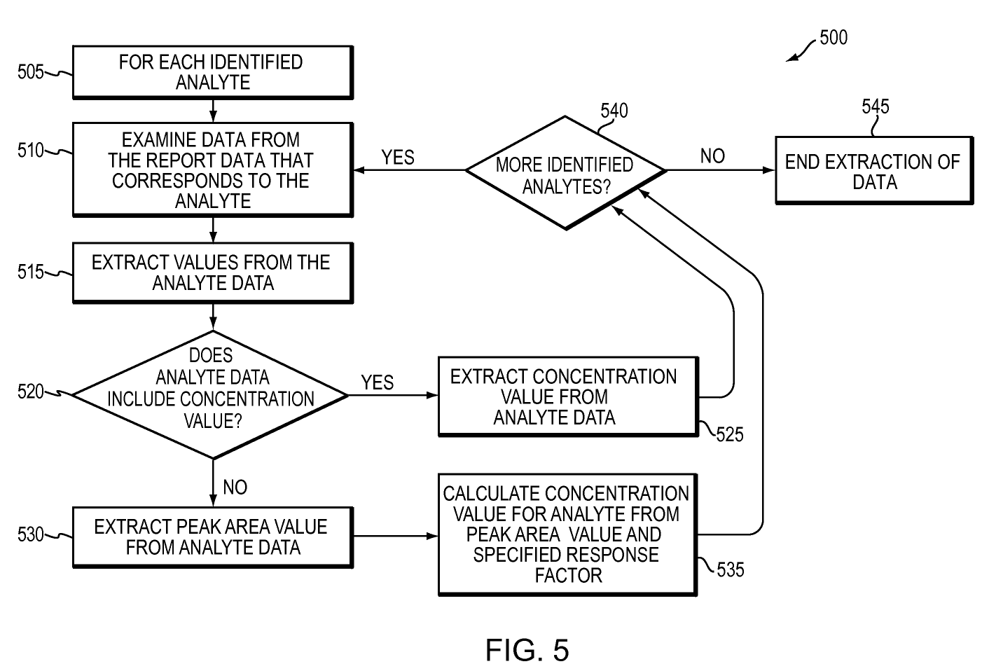

FIG. 5 is a detailed flow diagram illustrating an example method 500 of extracting a subset of data corresponding to a subset of analytes in an example method for process control. For each identified analyte (505), report data that corresponds to the analyte is examined (510) and certain values for that analyte are extracted from the data (515). The illustrated embodiment 500 extracts the analyte's concentration value from the report data. To do so, the embodiment determines whether the report data for the analyte includes a concentration value (520). If so, the concentration value is extracted from the data (525). However, if the report data does not include a concentration value, then the embodiment extracts the analyte's peak area from the data (530) and calculates the analyte's concentration value using the analyte's peak area and a response factor specified for the analyte (535). The peak value is obtained from the report data and the response factor is a predetermined factor for the analyte. Generally, the response factor may be predetermined by dividing a known peak area for the analyte by the analyte's known concentration value for that peak area. Calibration curves for the analyte may be used to accomplish the predetermination of the response factor, where the calibration curves are two-dimensional graphs of peak area versus concentration value for the analyte. Once the values for the analyte are extracted from the data, the method determines whether there are any more identified analytes for which data is to be extracted (540). If so, then the method continues to examine the report data (510). If not, then the data extraction ends (545).

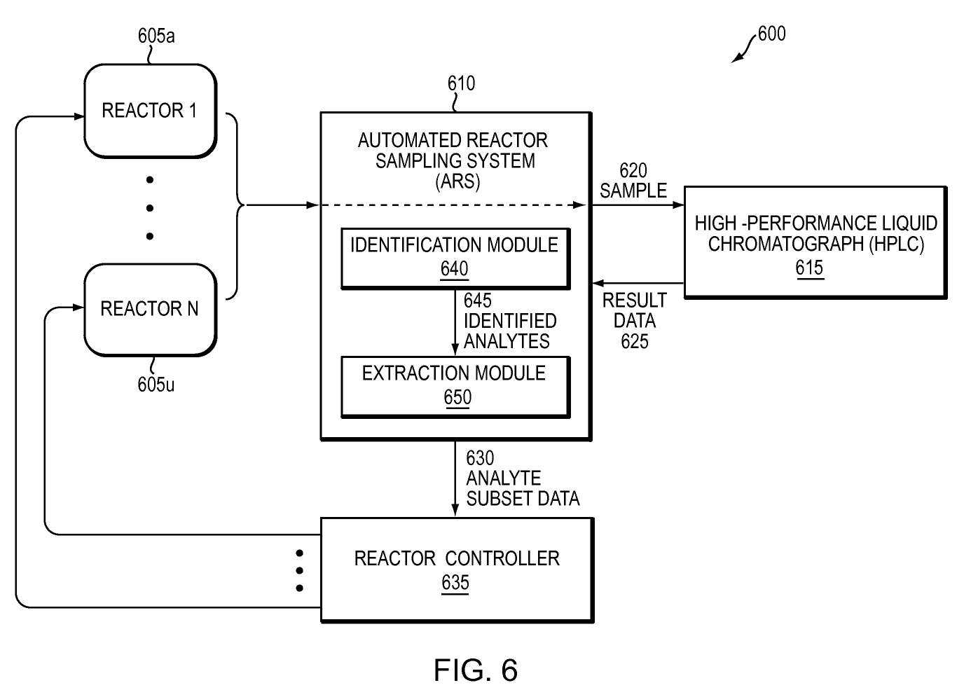

FIG. 6 is a block diagram illustrating an example embodiment 600 in which an Automated Reactor Sampling (ARS) system 610 is configured to control a reactor process. As referred to herein, the ARS 610 includes both hardware used to obtain a sample from the reactor and associated software used to control the hardware. The ARS 610 includes an identification module 640 that is configured to automatically identify a subset of analytes 645 from a large number of analytes that are able to be analyzed by an HPLC 615. The ARS 610 also includes an extraction module 650 that is configured to automatically extract a subset of data 630 from the HPLC's result data 625, where the result data 625 relates to a liquid mixture sample 620 from a reactor 605 that is provided to the HPLC 615 by the ARS 610, and where the subset of data 630 corresponds to the subset of analytes 645. The ARS 610 further includes an interface that is configured to transfer the subset of data 630 to an application 635 (e.g., reactor controller) associated with the reactor 605 to control the reactor 605 in response to the subset of data 630. The interface may be a wired or wireless interface, such as, for example, a serial port, twisted-pair Ethernet, or 802.11g connection.

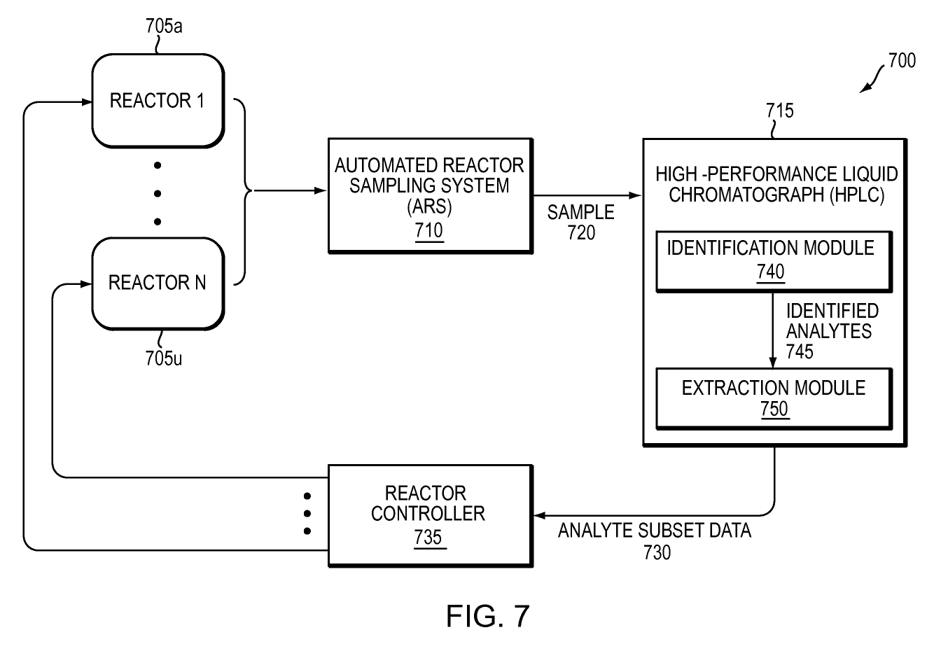

FIG. 7 is a block diagram illustrating an example embodiment 700 in which a High-Performance Liquid Chromatograph (HPLC) 715 configured to control a reactor process. The HPLC 715 includes an identification module 740 that is configured to automatically identify a subset of analytes 745 from a large number of analytes that are able to be analyzed by the HPLC 715. The HPLC 715 also includes an extraction module 750 configured to automatically extract a subset of data 730 from data resulting from liquid chromatography of a liquid mixture sample 720 from a reactor 705, where the subset of data 730 corresponds to the subset of analytes 745. The HPLC 715 further includes an interface that is configured to transfer the subset of data 730 to an application 735 (e.g., reactor controller) associated with the reactor 705 to control the reactor 705 in response to the subset of data 730.

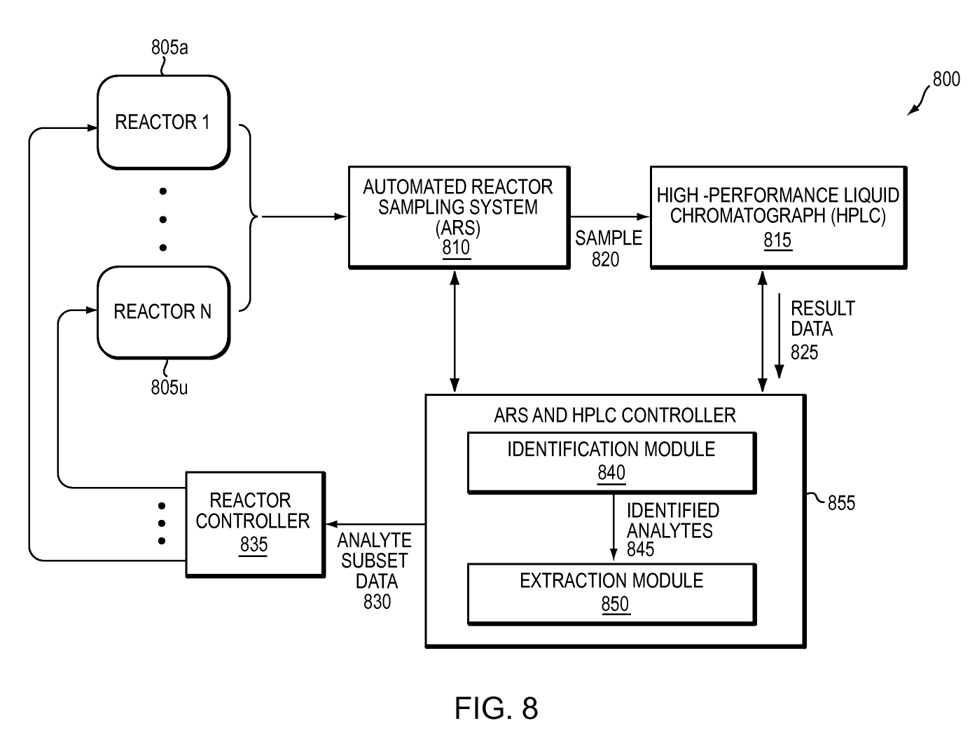

FIG. 8 is a block diagram illustrating an example embodiment 800 in which a separate device 855 that controls the ARS 810 and HPLC 815 is configured to control a reactor process. The separate device 855 may be a general purpose computer or specialized device in electronic communication with the ARS 810 and HPLC 815. According to the example embodiment 800, the device 885 includes an identification module 840 that is configured to automatically identify a subset of analytes 845 from a large number of analytes that the HPLC 815 is able to analyze. The device 885 also includes an extraction module 850 that is configured to automatically extract a subset of data 830 from the HPLC's result data 825 relating to a liquid mixture sample 820 from a reactor 805, where the subset of data 830 corresponds to the subset of analytes 845. The device 855 further includes an interface that is configured to transfer the subset of data 830 to an application 835 (e.g., reactor controller) associated with the reactor 805 to control the reactor 805 in response to the subset of data 830.

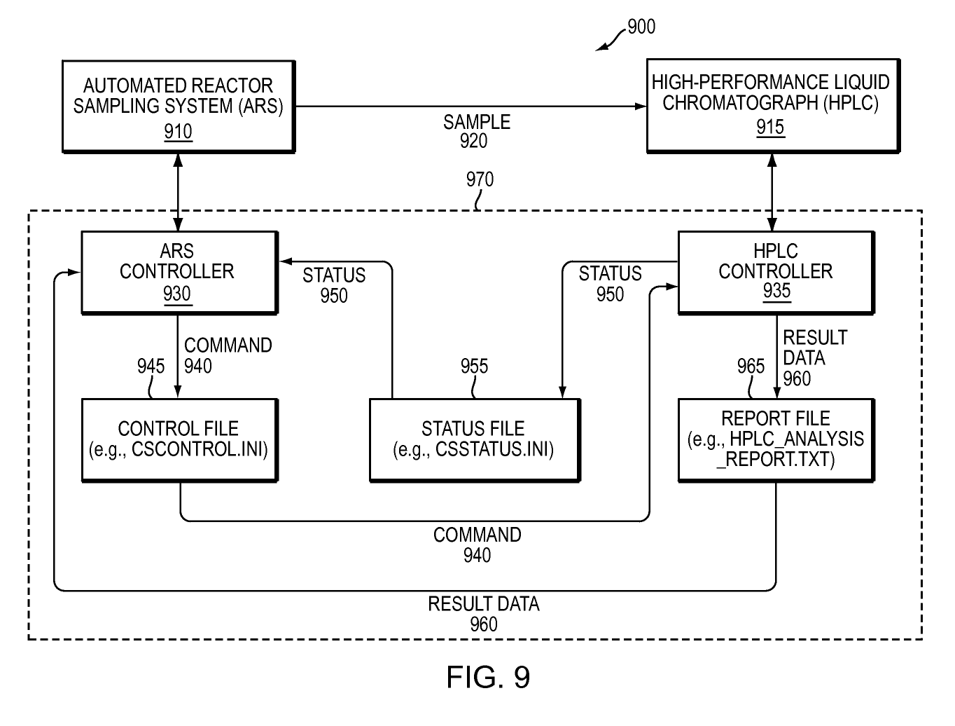

FIG. 9 is a block diagram illustrating an example embodiment 900 including files that are accessed by an ARS controller 930 and an HPLC controller 935 and that are used to pass information between the ARS 910, HPLC 915, and associated controllers 930, 935. Illustrated by the dashed box is a shared memory space 970, such as memory of a general purpose computer, in which the controllers 930, 935 and files 945, 955, 965 may reside. As can be appreciated, the controllers 930, 935 and files 945, 955, 965 may also reside in separate memories or devices that are in communication with each other.

The ARS 910 may take control of the HPLC 915 by way of, for example, a macro (i.e., small software program). The macro may be part of the ARS controller 930 and allows the ARS 910 to send commands 940 to the HPLC 935. The commands 940 may, for example, control the HPLC's 915 injection of the sample 920 into the HPLC's column. Both the ARS controller 930 and the HPLC controller (or other similar application) 935 may reside on one computing device 970. In embodiments that include HPLC systems made by Agilent®, for example, the application that controls the HPLC 915 may be a an application called ChemStation. In one embodiment, the two controllers 930, 935 communicate via a control file 945 (e.g., CSCONTROL.INI) and a status file 955 (e.g., CSSTATUS.INI). The controllers 930, 935 may be configured such that the ARS controller 930 is a master and the HPLC controller 935 is a slave.

According to the example embodiment, the HPLC controller 935 looks to the control file 945 file for commands from the ARS controller 930. For the ARS controller 930 to send a command 940 to the HPLC controller 935, it writes a command 940 to the control file 945. The HPLC controller 935 reads the command 940 from the control file 945 and takes an action relating to the command 940. When the HPLC 915 has completed the action relating to the command 940, the HPLC controller 935 writes status information 950 to the status file 955. The ARS controller 930 waits for the status information 950 to be written to the status file 955 and, when written, reads the status information 950. If the ARS controller 930 had issued a command 940 for the HPLC 915 to run a sample 920 and the status information 950 indicates that the command 940 has been executed, the ARS controller 930 then looks for a report file 965 (e.g., HPLC_ANALYSIS_REPORT.TXT) produced by the HPLC 915 that includes result data 960 relating to the sample 920. In embodiments that include an HPLC system made by Agilent®, the file may be named AGILENT_HPLC_ANALYSIS_REPORT.TXT. Once the report file 965 is located, the system 900 may begin the parsing of the report data 960, as described above.

FIG. 10 is a block diagram illustrating an example embodiment 1000 for generating analyte data files and associated Object Linking and Embedding for Process Control (OPC) tags. The illustrated embodiment 1000 is similar to other embodiments described herein, but further includes an HPLC wizard 1025 used for analyte identification and data calculations. The embodiment includes an Agilent® HPLC instrument (not shown) that is controlled by Agilent's ChemStation software application 1005. The application 1005 generates a result file 1010, as previously described. According to the embodiment 1000, an ARS controller 1015 analyses the data from the result file 1010 and generates another data file 1020 regarding that analysis. The wizard 1025 may then perform additional analysis of the data; for example, the wizard may further reduce the subset of analytes in the file 1020 produced by the ARS 1015. Alternatively, the ARS 1015 could simply convert the HPLC's result file 1010 into a proprietary format, and the wizard 1025 may then perform the identification of the analytes of interest and extraction of related data. The wizard 1025 may also convert the extracted data into an Object Linking and Embedding for Process Control (OPC) compliant format and write the data to an OPC data file 1030. The OPC data file 1030 is forwarded to or read by an OPC server 1040, which creates individual tags 1045 for each analyte and its data values, which allow for efficient access of the data. The OPC server 1040 provides the tags 1045 to a OPC client upon request. An OPC protocol file 1055, generated by the wizard 1025, may be used by the OPC server 1040 to understand and process the OPC data file 1030. The wizard 1025 may also write the data to a historical analytical data file 1035, which may, for example, contain all HPLC analysis data on samples from a specific reactor.

A user of the system 1000 may use the wizard 1025 to generate HPLC analyte definition files 1050 that are used to identify or filter the analytes of interest from the HPLC instrument's analysis data 1010. Identification or data filtration may be accomplished, for example, in one of two methods: (1) using a list of analyte names in the HPLC analyte definition file 1050 to identify or filter analytes from the HPLC instrument's analysis data 1010 by matching analyte names in the HPLC analyte definition file 1050 to analyte names in the analysis data 1010, or (2) if analyte names are not included in the HPLC instrument's analysis data 1010, the analytes' retention time values are examined to determine whether the values fall within specified retention time ranges provided for the analytes in the HPLC analyte definition file 1050. As described above, if the analytes' concentration values are not included in the HPLC instrument's analysis data 1010, the wizard 1025 may calculate the concentration value based on a predetermined response factor provided in the HPLC analyte definition file 1050.

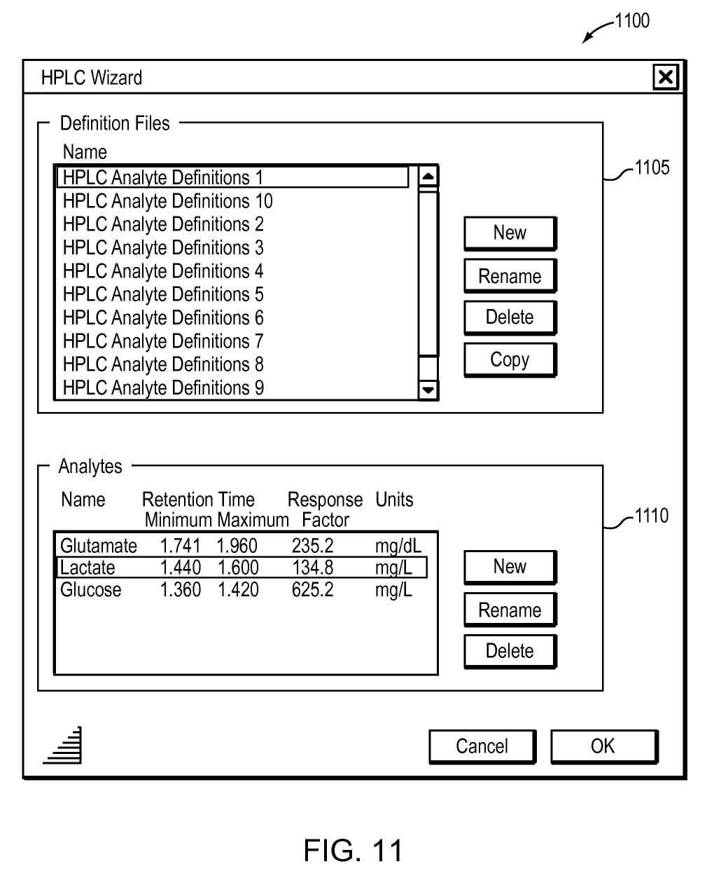

FIG. 11 illustrates an example user interface 1100 of the wizard 1025 described above. As shown, the interface 1100 allows a user to manipulate overall analyte definition files 1105, and allows the user to add, delete, or modify individual analytes 1110 defined in the files.

While this invention has been particularly shown and described with references to example embodiments thereof, it will be understood by those skilled in the art that various changes in form and details may be made therein without departing from the scope of the invention encompassed by the appended claims.

It should be understood that the flow diagrams of FIGS. 3-5 and the block diagrams of FIGS. 2 and 6-10 are examples that can include more or fewer components, be partitioned into subunits, or be implemented in different combinations. Moreover, the embodiments disclosed herein may be implemented in hardware, firmware, or software. If implemented in software, the software may be written in any suitable software language, and may be embodied on any form of tangible computer readable medium, such as RAM, ROM, or magnetic or optical disk, and loaded and executed by generic or custom processor(s).

The embodiments presented herein are described in the context of High-Performance Liquid Chromatography (HPLC) analysis, but as should be appreciated by those skilled in the art, the inventive concepts present in the disclosed embodiments may be equivalently applied to similar analytical systems, and not limited to just HPLC. Such similar analytical systems include, but are not limited to, mass or optical spectroscopy, nmr spectroscopy, Electron Spectroscopy for Chemical Analysis (ESCA), or any analytical system that generates or formulates data in a multidimensional, multi-analyte data report. Further, the HPLC instruments included in the embodiments are not limited to just one HPLC instrument manufacturer, but can include HPLC instruments from any HPLC manufacturer.

What is claimed is:

1. A method for process control, the method comprising:
automatically identifying a subset of analytes from a plurality of analytes able to be analyzed by a liquid chromatograph;
automatically extracting a subset of data from the liquid chromatograph, the data relating to a liquid mixture sample from a reactor, and the subset of data corresponding to the subset of analytes;
transferring the subset of data to an application associated with the reactor; and
controlling the reactor in response to the subset of data.

2. A method as in claim 1 wherein automatically identifying the subset of analytes includes examining groups of data output from the liquid chromatograph, each group of data corresponding to a respective analyte detected by the liquid chromatograph.

3. A method as in claim 2 wherein examining the groups of data includes determining whether the liquid chromatograph has been calibrated for a given analyte based on whether a corresponding group from the groups of data includes a name for the given analyte, and wherein automatically identifying a subset of analytes includes identifying the given analyte if the liquid chromatograph has been calibrated for the given analyte.

4. A method as in claim 2 wherein automatically identifying a subset of analytes includes identifying a given analyte if a corresponding group from the groups of data includes a retention time for the given analyte that is within a specified range.

5. A method as in claim 1 wherein extracting a subset of data from the liquid chromatograph includes obtaining the data relating to a liquid mixture sample from a report output by the liquid chromatograph or from internal registers of the liquid chromatograph.

6. A method as in claim 1 wherein extracting a subset of data includes extracting groups of data that correspond to the subset of analytes.

7. A method as in claim 6 wherein extracting groups of data includes extracting certain values from each group of data.

8. A method as in claim 7 wherein the certain values include any of analyte name, analyte type, retention time, peak width, peak area, peak area percent, and concentration.

9. A method as in claim 7 wherein extracting certain values from each group of data includes extracting fewer values from each group than are present in the group.

10. A method as in claim 6 wherein extracting groups of data includes, for each group of data, calculating a concentration value of the corresponding analyte based on a peak area value of the analyte, as included in the group of data, and a specified response factor for the analyte in an event that the group of data does not include a concentration value for the analyte.

11. A method as in claim 1 wherein extracting the subset of data includes formatting the subset of data into an Object Linking and Embedding for Process Control (OPC) compliant format.

12. A process control device comprising:
an identification module configured to automatically identify a subset of analytes from a plurality of analytes able to be analyzed by a given analytical instrument;
an extraction module configured to automatically extract a subset of data from the given analytical instrument, the data relating to a liquid mixture sample from a reactor, and the subset of data corresponding to the subset of analytes; and
an interface configured to transfer the subset of data to an application associated with the reactor to control the reactor in response to the subset of data.

13. A process control device as in claim 12 wherein the given analytical instrument is a liquid chromatograph.

14. A process control device as in claim 12 wherein the identification module is configured to examine groups of data output from the given analytical instrument, each group of data corresponding to a respective analyte detected by the given analytical instrument, and to identifying a given analyte if the group of data corresponding to the analyte (i) includes a name for the given analyte or (ii) indicates for the given analyte a retention time that is within a specified range.

15. A process control device as in claim 12 wherein the extraction module is configured to extract groups of data that correspond to the subset of analytes and, for each group of data, calculate a concentration value of the corresponding analyte based on a peak area value of the analyte, as included in the group of data, and a specified response factor for the analyte in an event that the group of data does not include a concentration value for the analyte.

16. A process control device as in claim 12 wherein the process control device is an automated reactor sampling device.

17. A process control device as in claim 12 wherein the process control device is a liquid chromatograph.

18. A process control device as in claim 12 wherein the process control device is a device in communication with an automated reactor sampling device and the given analytical instrument.

19. A process control device as in claim 12 wherein the extraction module is configured to obtain the data relating to a liquid mixture sample from a report output by the given analytical instrument or from internal registers of the given analytical instrument.

20. A method for process control, the method comprising:
automatically identifying a subset of analytes from a plurality of analytes able to be analyzed by a given analytical instrument;
automatically extracting a subset of data from the given analytical instrument relating to the process, the subset of data corresponding to the subset of analytes;
controlling the process in response to the subset of data.
